(19) United States
(12) Patent Application Publication
(10) Pub. No.: US 2007/0044322 A1
(43) Pub. Date: Mar. 1, 2007

(54) Multi-tool with strap cutter

(76) Inventors: Nicholas D. Trbovich JR., Orchard Park, NY (US); Kathlyn Susan Green, Machias, NY (US)

Correspondence Address: JAECKLE FLEISCHMANN & MUGEL, LLP, 190 Linden Oaks, ROCHESTER, NY, 14625-2812, US

(21) Appl. No.: 11/343,671

(22) Filed: Jan. 31, 2006

Related U.S. Application Data
(63) Continuation-in-part of application No. 11/028,091, filed on Jan. 3, 2005.
(60) Provisional application No. 60/534,044, filed on Jan. 2, 2004.

(51) Int. Cl. B26B 29/00

(52) U.S. Cl. 30/294

(57) ABSTRACT

The invention comprises a strap cutter that can be used with one hand to cut straps such as those used for seat belts and parachutes, and to score and break materials. The strap cutter may comprise a handle, a cutting head, and a driver tip. The strap cutter may further comprise a sharpening element or a pyrophoric material. In another embodiment, the invention comprises a strap cutter that can be used with one hand to cut straps and can also be used to start a fire. The strap cutter may comprise a handle made of a combustible metal or combustible metal alloy, a cutting head, and a pyrophoric material. In yet another embodiment, the strap cutter is incorporated into a multi-tool.

### CROSS-REFERENCE TO RELATED APPLICATIONS

This application claims the benefit of U.S. Provisional Application No. 60/534,044, filed on Jan. 2, 2004 and is a continuation-in-part of U.S. application Ser. No. 11/028,091, filed on Jan. 3, 2005.

### STATEMENT REGARDING FEDERALLY SPONSORED RESEARCH OR DEVELOPMENT

Not applicable.

### BACKGROUND OF THE INVENTION

A single, durable tool is required in the art to perform several functions including rapidly cutting through straps such as seat belts and scoring and breaking materials such as glass or PLEXIGLAS®. This tool would be useful in situations where one needs to quickly escape from a vehicle. For example, an aviator in a downed aircraft may need to escape quickly if the aircraft has been downed in a body of water. A tool is needed that would allow an aviator in such a situation to rapidly cut the seat belt with one hand and then score and break the windshield with one hand.

### BRIEF SUMMARY OF THE INVENTION

The invention comprises, in one form thereof, a strap cutter that can be used with one hand to cut straps such as those used for seat belts and parachutes. The strap cutter comprises a handle having a first end and a second end, a cutting head attached to the first end of the handle, and a driver tip attached to the second end of the handle. The hardened driver tip may be used as a screw driver or to score and break materials such as glass and PLEXIGLAS®. The strap cutter may further include a sharpening element or a pyrophoric material attached to the handle.

In another embodiment, the strap cutter comprises a handle having a first end and a second end, the handle being made of a combustible metal or combustible metal alloy, a cutting head attached to the first end of the handle, and a pyrophoric material attached to the handle. The handle can be scraped with a knife or other instrument to generate flakes of the combustible metal or combustible metal alloy, and the pyrophoric material can be used to generate a spark to ignite the flakes. This embodiment thus has the additional utility of being useful for starting a fire.

In yet another embodiment of the invention, the strap cutter is incorporated into a multi-tool having a main tool with a pair, of pivoting jaws operable by a respective pair of handles. The strap cutter is provided as an auxiliary tool pivotally connected to one of the handles. The strap cutter includes first and second blades arranged at an acute angle to each other. One or both of the blades may be serrated. In the preferred embodiment, the strap cutter is foldable to a non-use position inside an opening of the handle to which it is attached. One or more additional auxiliary tools (e.g., knife, screw driver, can opener, etc.) may be pivotally connected to one or both of the main tool handles. The handle of the strap cutter may further be made of or incorporate combustible material as described in the other embodiments herein.

Additional objects, advantages and novel features of the present invention will be set forth in part in the description which follows, and will, in part, become apparent in the practice of the invention when considered with the attached figures.

### BRIEF DESCRIPTION OF THE SEVERAL VIEWS OF THE DRAWINGS

The accompanying drawings form a part of this specification and are to be read in conjunction therewith, wherein like reference numerals are employed to indicate like parts in the various views, and wherein:

FIG. 1 is a front view of the strap cutter of the present invention;

FIG. 2 is a perspective view of the strap cutter handle and support plate of FIG. 1;

FIG. 3 is a left side view of the strap cutter handle and support plate of FIG. 2a;

FIG. 4 is a right side view of the strap cutter of FIG. 1;

FIG. 5 is a perspective view of the upper blade of FIG. 1;

FIG. 6 is a perspective view of the lower blade of FIG. 1;

FIGS. 7 and 8 are perspective views of the blade cover of FIG. 1;

FIG. 9 is a perspective view of the driver tip of FIG. 1;

FIG. 10 is a front view of another embodiment of the strap cutter of the present invention;

FIG. 11 is a perspective view of another embodiment of the invention showing the strap cutter incorporated into a multi-tool with the main tool in an open position and some auxiliary tools in a partly opened position and others in a folded away position; and

FIG. 12 is a perspective view of the tool of FIG. 11 showing the main tool in the folded position and some of the auxiliary tools in a partly open position.

### DETAILED DESCRIPTION OF THE INVENTION

An embodiment of the invention provides a strap cutter which comprises: a handle having a first end and a second end; a cutting head attached to the first end of the handle; and a driver tip attached to the second end of the handle.

The handle has one or more depressions of a size to accommodate one or more fingers. These depressions enable a better grip of the handle. The handle can be made of any suitable material, but is preferably made of a strong, durable, yet lightweight material. In one embodiment, the handle is made of aluminum or an aluminum alloy, such as Al Alloy 360. In another embodiment, of particular use when the strap cutter is to be used for fire starting, the handle is made of a combustible metal or combustible metal alloy. Combustible metals are generally defined as those metals which are easy to ignite when they reach a high specific area ratio (for example, as thin sections or flakes, or as fine particles or in finely divided form). The same metals, in massive solid form, are comparatively difficult to ignite. Such combustible metals include magnesium, titanium, sodium, potassium, lithium, zirconium, hafnium, calcium, zinc, plutonium, uranium, and thorium, and aluminum, iron, and steel. Of these, magnesium is the preferred material for the handle of the strap cutter, and aluminum is also a useful material for the handle. Other combustible metals have attributes making them either too expensive for practical use as handle materials (i.e., zirconium and hafnium), or too explosive (i.e., sodium), or dangerously radioactive (i.e., plutonium, uranium, and thorium).

In regard to magnesium, magnesium ribbons and shavings can be made by scraping the magnesium handle with a suitable instrument, such as a steel knife blade held perpendicular to the magnesium handle. The resulting magnesium ribbons and shavings can be ignited under certain conditions at about 510 degrees C. and finely divided magnesium powder can be ignited below 482 degrees C. Metal marketed under different trade names and commonly referred to as magnesium may be one of a large number of different alloys containing magnesium, but also significant percentages of aluminum, manganese, and zinc. Some of these alloys have ignition temperatures considerably lower than pure magnesium, and certain magnesium alloys will ignite at temperatures as low as 427 degrees C. Flame temperatures of magnesium and magnesium alloys can reach 1,371 degrees C. Thin, small pieces, such as ribbons, chips, and shavings, may be ignited by a match flame whereas castings and other large pieces are difficult to ignite even with a torch.

The cutting head of the strap cutter of the subject invention has a first sharpened edge (having one end and a second end) and a second sharpened edge (also having one end and a second end). The first sharpened edge is positioned relative to the second sharpened edge such that the first sharpened edge engages the second sharpened edge at the one end of each, and forms a gap at the second end of each. The edges are thus positioned in a “V” shape. The sharpened edges may be smooth or serrated, as desired. The cutting head may be made of a continuous single piece of material with the two sharpened edges, or may be made of two separate pieces of material (one having the first sharpened edge and the other having the second sharpened edge).

The driver tip of the strap cutter of the subject invention preferably has a wedge-shaped portion.

The strap cutter may further comprise a sharpening element attached to the handle.

The strap cutter may further comprise a pyrophoric material attached to the handle, with this embodiment being of particular use when the strap cutter is also to be used for fire starting. A “pyrophoric material” as used herein is any material that emits sparks when rubbed, scratched, or struck. Flint is a common pyrophoric material, which emits sparks when rubbed, scratched, or struck with steel such as a steel knife blade. Synthetic or artificial flints are generally made from a metal called cerium together with iron (the pyrophoric alloy ferrocerium). When scraped with a hard edge, such as a steel knife blade or the back of a steel knife, or chips from rocks, ferrocerium gives off long-lived, hot sparks. These sparks can be used to ignite the magnesium shavings referred to above, producing a white hot flame. Alternative pyrophoric materials could be two pieces of iron pyrite, which, when struck together, throw off a shower of hot sparks. Iron pyrite and steel will also give a hot spark. Quartz and steel, or two pieces of quartz, will also give off good sparks.

The strap cutter may further comprise a wrist band attached to the handle.

In another embodiment, the strap cutter of the present invention comprises: a handle having a first end and a second end, the handle being made of a combustible metal or combustible metal alloy; a cutting head attached to the first end of the handle; and a pyrophoric material attached to the handle.

This embodiment may further comprise a driver tip attached to the second end of the handle, a sharpening element attached to the handle, and/or a wrist band attached to the handle.

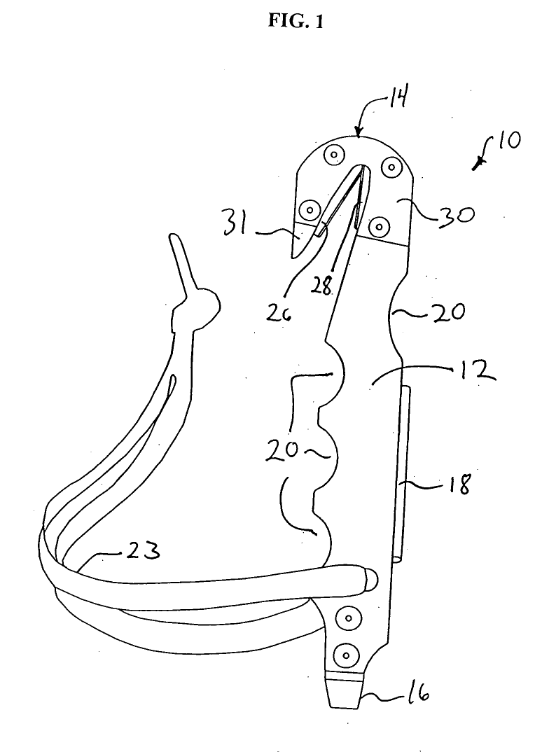

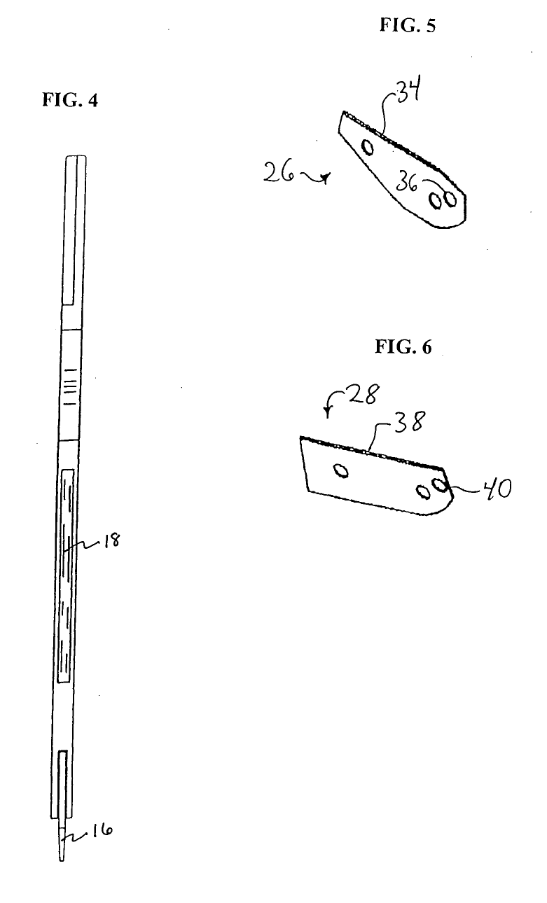

Referring now to the drawings, FIGS. 1 and 4 show a strap cutter of the present invention. The strap cutter 10 includes a handle 12, a cutting head 14, a driver tip 16, and a sharpening rod 18.

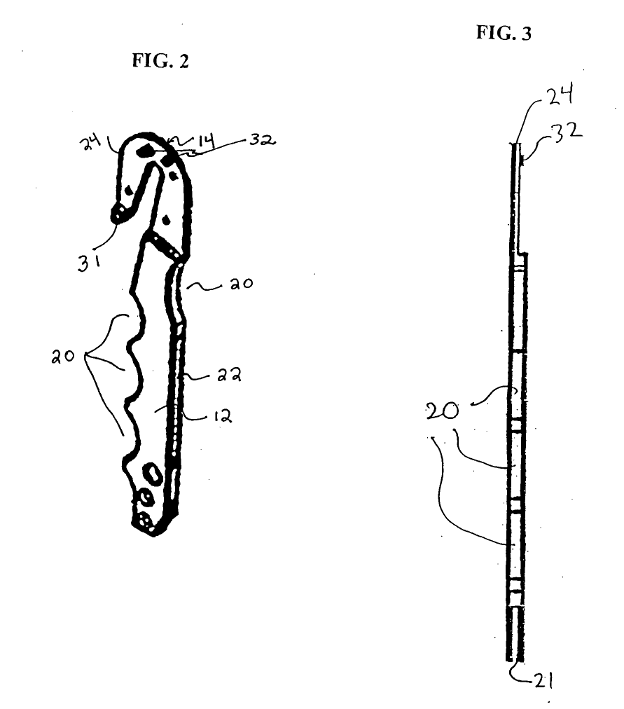

Referring to FIGS. 1 and 2, the handle 12 includes one or more depressions 20 for accommodating the user's fingers. The depressions 20 allow the user to securely grip the handle 12 while using the strap cutter 10. The handle 12 further includes a bifurcation 21 for engaging the driver tip 16 (see FIG. 3), a slot 22 for engaging the sharpening rod 18, and a band 23. The handle 12 is preferably made of an aluminum alloy such as Al Alloy 360 and has a black anodized finish, preferably according to US military standards. Therefore, the handle 12 is lightweight and durable.

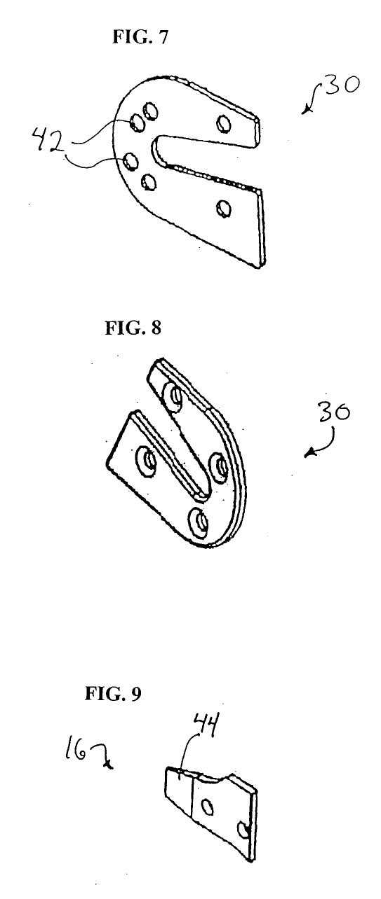

The cutting head 14 includes a support plate 24, an upper blade 26, a lower blade 28, and a blade cover 30. The support plate 24 is preferably integral with the handle 12 and includes protuberances 32 to aid in positioning of the upper blade 26, the lower blade 28, and the blade cover 30. The support plate 24 further includes a tip 31. The distance between the tip 31 and the handle 12 is smaller than the width of the average finger to prevent a finger from slipping between the upper blade 26 and the lower blade 28, which could cause injury. The upper blade 26 is preferably affixed to the support plate 24 by fasteners such as screws or rivets. The upper blade 26 includes a sharpened edge 34 and a through hole 36 for engaging a protuberance 32, which is best shown in FIG. 5. The lower blade 28 is preferably affixed to the support plate 24 by fasteners such as screws or rivets. The lower blade 28 includes a sharpened edge 38 and a through hole 40 for engaging a protuberance 32, which is best shown in FIG. 6. The upper blade 24 and the lower blade 26 are preferably made of stainless steel. FIGS. 7 and 8 show that the blade cover 30 is preferably affixed to the support plate by fasteners such as screws or rivets and includes blind bores 42 for engaging protuberances 32. The blade cover 30 is preferably made of an aluminum alloy such as Al Alloy 380 and has a black anodized finish, preferably according to US military standards.

Referring to FIGS. 1, 3 and 9, the driver tip 16 engages the bifurcation 21 in the handle 12 and is affixed to the handle 12 by fasteners such as screws or rivets. The driver tip is preferably made of a hardened tool steel and includes a wedge-shaped portion 44 so that it may be used as a scoring tool or a flat head screwdriver.

The sharpening rod 18 is shown in FIG. 1 and is preferably made of a ceramic material such as alumina ceramic. The sharpening rod 18 is securely fastened to the slot 22 of the handle 12, preferably by a tight friction-fit within the slot 22.

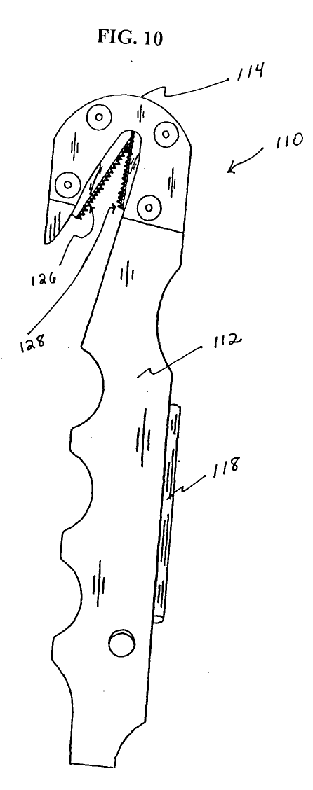

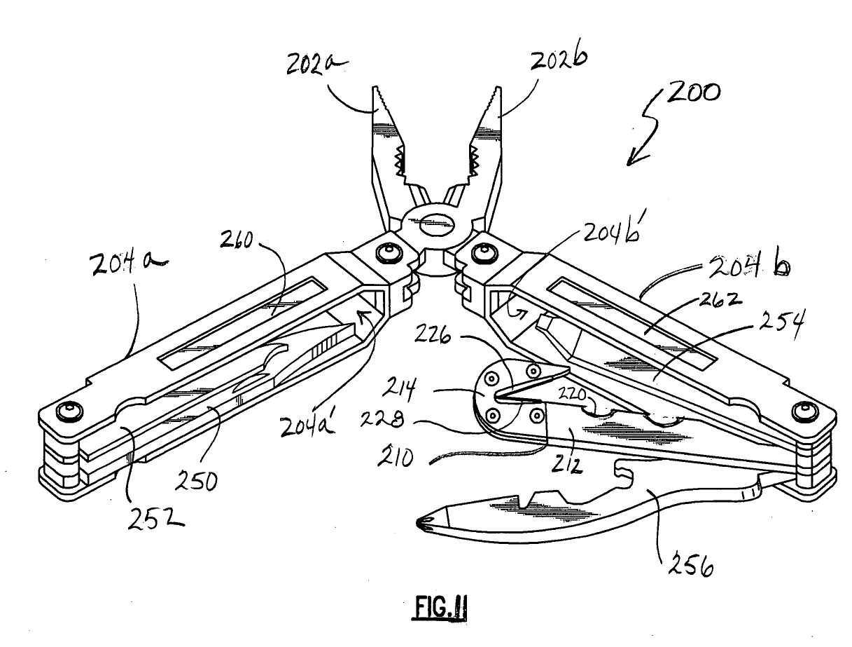

In an alternate embodiment, as shown in FIG. 10, the strap cutter 110 includes a handle 112 made of magnesium, a cutting head 114, and a ferrocerium element 118. In this embodiment, the cutting head 114 includes an upper serrated blade 126 and a lower serrated blade 128.

In use, the strap cutter can perform several functions. The cutting head may be used to rapidly cut straps such as seat belt restraints and parachute straps. The user simply grasps the handle and slides the cutting head over a strap that is to be cut such that the strap is positioned between the tip and the handle. The user then pulls the strap cutter such that the strap is wedged between the upper blade and the lower blade thereby cutting the strap.

The driver tip may be used as a flat head screw driver. Further, the driver tip may be used to score and break materials such as glass and PLEXIGLAS® or to punch through metal.

The sharpening element may be used to sharpen blades such as survival knives and bayonets. Further, the cutting head may be disassembled such that the upper blade and the lower blade may be sharpened on the sharpening element.

The handle, when made of a combustible metal or combustible metal alloy, can be struck or scraped or otherwise used to generate shavings for fire-starting.

The pyrophoric element may be used to generate sparks to ignite a combustible material, such as the shavings from the handle or other tinder.

It should be particularly noted that the strap cutter can be used with one hand to cut straps and to score and break materials. Both functions, cutting and scoring/breaking, can be performed without any adjustment or re-configuring of the strap cutter, since the cutting head and the driver tip are on opposite ends of the cutting tool and ready-to-use. In survival applications, this ready-to-use aspect can be life-saving. The addition of the fire-starting utility to the strap cutter adds to its benefits in survival applications.

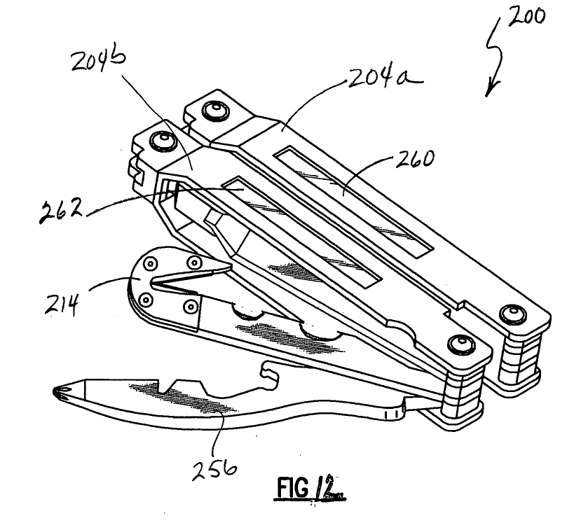

In yet a further embodiment of the invention, the strap cutter head and handle is incorporated into a multi-tool such as multi-tool 200 seen in FIGS. 11 and 12. Multi-tool 200 has a main tool which may be in the form of pliers having pivoting jaws 210a, 210b operable by a pair of respective handles 212a, 212b. Strap cutter head 214 is pivotally secured to main tool handle 204b at the end of handle 212 opposite strap cutter head 214. Strap cutter head 214 includes sharpened edges 226, 228 arranged in a “V” shape. The construction and assembly of strap cutter head 214 is essentially identical to the strap cutter 10 embodiment of the invention described above and may include any of the embodiments and features described above. For example, handle 212 may be provided with depressions 220 allow the user to securely grip the handle 212 while using the strap cutter head 214. Further, the handle 212 may be made of a combustible metal or combustible metal alloy and a pyrophoric material attached to the handle.

Additional auxiliary tools may be pivotally connected to one or both of main tool handles 204a, 204b, such as knives 250, 252 on handle 204a, and sharpening element 254 and driver/opener implement 256 on handle 204b, for example. One or both of main tool handles 204a, 204b may include an opening 204a′, 204b′ wherein the auxiliary tools may fold away when not in use. Further, one or both of main tool handles 204a, 204b may include a window 260, 262 for viewing the auxiliary tools therein for quick selection. As seen in FIG. 12, main tool handles 204a, 204b may pivot away from each other and come to rest side-by-side wherein jaws 202a, 202b are encased between handles 204a, 204b when the main tool is not in use.

While particular embodiments of the invention have been shown, it will be understood, of course, that the invention is not limited thereto, since modifications may be made by those skilled in the art, particularly in light of the foregoing teachings. Reasonable variation and modification are possible within the scope of the foregoing disclosure of the invention without departing from the spirit of the invention.

1. A multi-tool comprising:
a) a first, main tool including a pair of pivotally connected jaws connected to and operable by a pair of respective handles;
b) a second tool comprising a strap cutter having cutting head attached to a strap cutter handle pivotally connected to one of said main tool handles, said one of said main tool handles having an opening wherein said strap cutter may be pivoted to a position within said opening when not in use and a position outside said opening when it is desired to use said strap cutter.

2. The multi-tool of claim 1 wherein the strap cutter handle has one or more depressions of a size to accommodate one or more fingers.

3. The multi-tool of claim 1 wherein the strap cutter handle is made of a combustible metal or combustible metal alloy.

4. The multi-tool of claim 3 wherein the combustible metal is aluminum.

5. The multi-tool of claim 3 wherein the combustible metal is magnesium.

6. The multi-tool of claim 1 wherein the cutting head has a first sharpened edge and a second sharpened edge, and wherein the first sharpened edge engages the second sharpened edge at one end and further wherein the first sharpened edge and the second sharpened edge form a gap at a second end.

7. The multi-tool of claim 6 wherein one or both of the first sharpened edge and the second sharpened edge are serrated.

8. The multi-tool of claim 6 wherein the first sharpened edge and the second sharpened edge are a single piece.

9. The multi-tool of claim 6 wherein the first sharpened edge and the second sharpened edge are two separate pieces.

10. The multi-tool of claim 1 and further comprising an auxiliary tool having a driver tip pivotally connected to one of said main tool handles.

11. The multi-tool of claim 1 further comprising an auxiliary tool having a sharpening element pivotally connected to one of said main tool handles.

12. The multi-tool of claim 1 further comprising a pyrophoric material attached to the strap cutter handle.

13. The multi-tool of claim 12 wherein the pyrophoric material is flint.

14. The multi-tool of claim 12 wherein the pyrophoric material is ferrocerium.

15. The multi-tool of claim 1 wherein the strap cutter handle is made of a combustible metal or a combustible metal alloy and wherein the strap cutter further comprises a pyrophoric material attached to the handle.

16. The multi-tool of claim 1 wherein said main tool is a pliers.

17. The multi-tool of claim 16 and further comprising one or more auxiliary tools attached to one or both of said main tool handles.

18. The multi-tool of claim 17 wherein said one or more of said auxiliary tools comprises a knife.

19. The multi-tool of claim 18 wherein said one or more of said auxiliary tools comprises a single implement having a driver and a can opener.

20. The multi-tool of claim 19 wherein both of said handles includes an opening wherein said strap cutter and said one or more auxiliary tools may be folded therein when not in use.

21. The multi-tool of claim 20 wherein aid main tool is foldable to a position wherein said jaws are positioned between said main tool handles when not in use.

22. The multi-tool of claim 16 wherein one or both of said handles include a window revealing said opening and tools positioned therein.

23. A multi-tool including a strap cutter pivotally connected thereto, said strap cutter comprising:
a) a handle having a first end and a second end, the handle being made of a combustible metal or combustible metal alloy;
b) a cutting head attached to the first end of the handle; and
c) a pyrophoric material attached to the handle.

24. The multi-tool of claim 23 wherein the handle has one or more depressions of a size to accommodate one or more fingers.

25. The multi-tool of claim 23 wherein the combustible metal is magnesium.

26. The multi-tool of claim 23 wherein the cutting head has a first sharpened edge and a second sharpened edge, and wherein the first sharpened edge engages the second sharpened edge at one end and further wherein the first sharpened edge and the second sharpened edge form a gap at a second end.

27. The multi-tool of claim 26 wherein one or both of the first sharpened edge and the second sharpened edge are serrated.

28. The multi-tool of claim 26 wherein the first sharpened edge and the second sharpened edge are a single piece.

29. The multi-tool of claim 26 wherein the first sharpened edge and the second sharpened edge are two separate pieces.

30. The multi-tool of claim 23 wherein the pyrophoric material is flint.

31. The multi-tool of claim 23 wherein the pyrophoric material is ferrocerium.

32. The multi-tool of claim 23 further comprising an auxiliary tool having a driver tip pivotally connected to said multi-tool.

33. The multi-tool of claim 23 further comprising an auxiliary tool having a sharpening element pivotally connected to said multi-tool.
